(19) United States
(12) Patent Application Publication
(10) Pub. No.: US 2017/0186003 A1
(43) Pub. Date: Jun. 29, 2017

(54) SECONDARY AUTHENTICATION OF NETWORK TRANSACTIONS

(71) Applicant: NCR Corporation, Duluth, GA (US)

(72) Inventor: Andrew David Monaghan, Dundee (GB)

(21) Appl. No.: 14/979,894

(22) Filed: Dec. 28, 2015

(51) Int. Cl. G06Q 20/40

(52) U.S. Cl. CPC G06Q 20/405; G06Q 20/4016

(57) ABSTRACT

Various embodiments herein each include at least one of systems, methods, and software for secondary authentication of network transactions. Some such embodiments, for example, provide a secondary authentication channel to authenticate and authorize payment tendering with a bankcard, payment account, and the like. One method embodiment includes determining whether to approve an account authorization request in view of other data stored in a database with regard to the account. When determined that the account authorization request is denied, transmitting a request to obtain a secondary authorization of the account authorization request.

### BACKGROUND INFORMATION

Fraud with regard to credit, debit, and other bankcards and associated solutions including payment services has become more prevalent. Many, if not most, people with a bankcard or payment service have experienced a fraud situation where an attempted fraudulent payment has been rejected or made against their account. Recent advancements in fraud detection have lessened such fraud instances, but the result has been that bankcards and payment accounts are frozen until reclaimed, activity is verified as non-fraudulent, or a new bankcard is issued. This has caused customers, retailers, and financial institutions much trouble and continued anxiety.

At the same time, retailers and financial Institutions are undertaking a strategic evolution of how they serve customers. This evolution is allowing more transactions to he completed entirely by a consumer—including high value transactions, for example a withdrawal from an account for an amount greater than typically available as part of a self-service transaction. However, higher value transactions come with higher risk.

### SUMMARY

Various embodiments herein each include at least one of systems, methods, and software for secondary authentication of network transactions. Some such embodiments, for example, provide a secondary authentication channel to authenticate and authorize payment tendering with a bankcard, payment account, and the like.

One embodiment, in the form of a method includes receiving an account payment authorization request for an amount that exceeds an allowed amount for the account and applying a rule against the account payment authorization request and other data available in a database with regard to the account to determine whether to approve the account payment authorization request. When application of the rule determines that the account payment authorization request is denied, the method includes transmitting a request to obtain a secondary authorization of the account payment authorization request.

Another method embodiment includes determining whether to approve an account authorization request in view of other data stored in a database with regard to the account. When determined that the account authorization request is denied, transmitting a request to obtain a secondary authorization of the account authorization request.

A further embodiment is in the form of a system that includes at least one processor, at least one memory device, and at least one network interface device. The system includes instructions stored on the at least one memory device that are executable by the at, least one processor to perform data processing activities. The data processing activities include receiving, via the at least one network interface device from a requestor, an account payment authorization request for an amount that exceeds an allowed amount for the account. The data processing activities then apply at least one rule against the account payment authorization request and other data available in a database with regard to the account to determine whether to approve the account payment authorization request. When application of the rule determines that the account payment authorization request is approved, an approval message is transmitted via the at least one network interface device to the requestor. However, when application of the rule determines that the account payment authorization request is denied, the data processing activities of the system include transmitting, via the at least one network interface device to the requestor, a request for a secondary authorization of the account payment authorization request.

### BRIEF DESCRIPTION OF THE DRAWINGS

FIG. 1 is a logical block diagram of a system, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems, methods, and software for secondary authentication of network transactions. Some such embodiments, for example, provide a secondary authentication channel to authenticate and authorize payment tendering with a bankcard, payment account, and the like. Bankcards may include credit and debit cards with a magnetic stripe and. “chip and PIN” solutions, and associated solutions such as mobile payments that may require a Personal Identification Number (PIN), password, biometric authentication, and the like. In some such embodiments, when a payment is tendered, a payment authorization request is received by a card issuer system. The request may be for any payment amount. When the amount of the payment request is greater than an available payment amount that may be limited by a daily transaction limit, a single transaction limit, or when the account has been locked or frozen due to possible or actual fraud detection, the card issuer system may require additional verification before authorizing the payment.

In one such embodiment, the card issuer system may look to additional evidence as to the veracity of the requested payment, such as by considering a location of where the payment tendering is being made in view of other data stored in a database with regard to the account. This other data may include location data as received from or with regard to a mobile device of the account holder in proximity to the location where the payment tendering is being made. This location data may be received based on BLUETOOTH® beacon data or global positioning system (GPS) data received by a card issuer system from an app that executes on the mobile device of the account holder. Other location may also or alternatively be considered, such as a location of one or more most recent transactions, known travel destinations, a location of a last login to a card issuer website as determined from a login source IP location, and the like. The other data may also consider the difference between the requested payment amount and the available payment amount. This data and other data may be considered and given a weighting for determining whether to approve the requested transaction.

When consideration of the other data does not result in approval of the payment request or in embodiments where other data considerations are not made, the card issuer system may send a message requesting further authentication. The message may be sent to the card holder, a clerk or teller where the payment tendering is being made.

The message may be sent to the card holder via a phone call by an automated interactive voice response system that requests authentication input from the customer. The message may also be sent via a text message, in-app message to an app that executes on a mobile device of the customer, and the like. In some such embodiments, the message may be presented in a user interface that requests authentication input or include a link to a webpage or other input mechanism through which additional authentication input can be received. The requested authentication input may be a password, PIN, biometric input such as a thumb or fingerprint or retinal scan, and other such inputs. In another embodiment, the message may include an image, such as an image of a barcode, that is to be provided for scanning within the transaction to authenticate the transaction. In yet another embodiment, the message may include a code or one-time PIN that is to be provided orally within the transaction for the additional authentication.

Regardless of how the request for secondary authentication is sent and eventually received, when the secondary authentication is input and received by the card issuer system and verified, the transaction request is then approved.

Such embodiments may be utilized in any number of contexts. For example, at teller and self-service Point-Of-Sale (POS) terminals and other self-service terminals such as Automate Teller Machines (ATMs) and online, Internet-based transactions, among others. Note as well that the various embodiments herein are also relevant in other contexts where a secondary authentication may be desired, such as upon providing an airline ticket associated with a known person, providing an electronic key to enter a facility where the electronic key is associated with a particular person, among other such presentments of items associated with a known person.

In embodiments when a message is sent to a clerk or teller, the message may be provided within a clerk or teller application or to a mobile device carried thereby. The message may instruct the clerk or teller to verify the customer's identity, such as by viewing a driver's license or other form of identification.

Such embodiments can he thought of as omni-channel experiences that provide a capability to take advantage of multiple types of interactions to complete a transaction. Such embodiments as described herein detail enterprise cloud omni-channel transaction authorization services that may be used across channels to use multiple-channel authentication mechanisms and multiple-channel evidence enrichment to make decisions on whether to authorize transactions.

Generally, a transaction is executed on one channel. Transaction request and authentication information is provided and received on this channel. Through configuration information, such as type of channel and type of transaction, some embodiments here will then decide if additional evidence or other channel authentication information is to be considered in authorizing the request.

Types of transaction include (but are not limited too):
Authorization of a withdrawal over a specified limit
Unlocking a credit card that has previously been blocked due to potentially fraudulent activity;
Authorization of immediate funds availability for a deposited check;
Unlocking a door;
Allowing a certain individual to pass a certain point; and
Other such identity verification situations.

All channels that initiate transaction can utilize the service including:
self service transactions (e.g., ATMs, kiosks, self-service POS terminals); mobile and online channels;
Teller Transactions;
Automated turnstiles where a keycard is needed for entry; and
The like.

The omni-channel transaction authorization service receives the transaction request from a channel. Through configuration it then decides whether additional evidence or multi-channel authentication is to be considered in authorizing the request.

When additional evidence of multi-channel authentication is to be considered, the service, in some embodiments, starts a configurable workflow to gather that information.

The first part of the workflow will attempt to gather enrichment evidence without consumer or staff member interaction. The omni-channel transaction authorization system is configured with evidence suppliers that can provide evidence weighting. Examples of evidence suppliers include:
Bluetooth beacons in a branch, facility, retail outlet, or other relevant location. If a Bluetooth beacon in the location of the channel can detect the presence of the consumer's mobile device, this provides a high positive evidence enrichment;
Mobile app login location. When the last login location for a mobile application is in the channel country, state, region, city, etc. (within a specified time period for example one day) this provides a low positive evidence enrichment. If the last login location was in a different country, state, region, city, etc. this provide a low negative evidence enrichment; and
Online login location, such as may be determined based on an IP address of a device from which the login occurred. In country/city—low to medium positive enrichment. Not in country/city low negative enrichment. The workflow continues evaluating the available evidence until exhausted. Additional evidence suppliers can be created to evaluate further criteria in various embodiments. When exhausted the omni-channel transaction authorization system can then decide if the transaction can be executed without further interaction.

When the omni-channel transaction authorization system deems the evidence insufficient or when this other data is not considered in an embodiment, the omni-channel transaction authorization system can then continue the configurable workflow to attempt to gather authentication from additional multi-channel sources. The Omni-Channel Transaction Authorization system may be configured with authentication suppliers that can prompt for additional authentication.

In some embodiments, this workflow may send signals back to the channel initiating the request to update its user interface to indicate additional authentication is required and the possible list of additional authentication mechanisms based upon the type of transaction, transaction value, and the channel that has initiated the transaction.

Authentication mechanism can include utilizing a consumer's device (e.g., mobile device or tablet) by initiating a push notification.. The push notifications can trigger the consumer to authorize the transaction via:
personal biometric;
logging into the financial institutions application;
providing a one-time PIN in the notification that can be entered on the channel;
allowing the consumer to scan a QR code displayed on the channels screen; and
among others

Note however that in some embodiments, this additional authentication may occur automatically based on a limited number of options, a user or entity configuration setting, and the like. Thus, a user may automatically receive an SMS message with a one--time PIN or an in-app message to provide a biometric authentication.

In some embodiments, when the consumer elects not to use their mobile device or mobile device usage is deemed inappropriate for the transaction-type or value, then the workflow can then employ alternative channel authentication mechanisms, which may include:
Using a self-service device (Card and PIN) to authorize the request; and
Push notification to a teller application (tablet or pc), alerting a teller in the same location as the channel to perform a physical review of the consumer—for example a driver's license check.

During the process of the workflow, the transaction is pending at the channel and at any point the consumer can elect to cancel the transaction, terminating the workflow. The workflow will then validate the secondary form of authentication to authorize a transaction. The workflow can use combinations of multiple forms of evidence and multiple forms of authentication to authorize the transaction in various embodiments.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

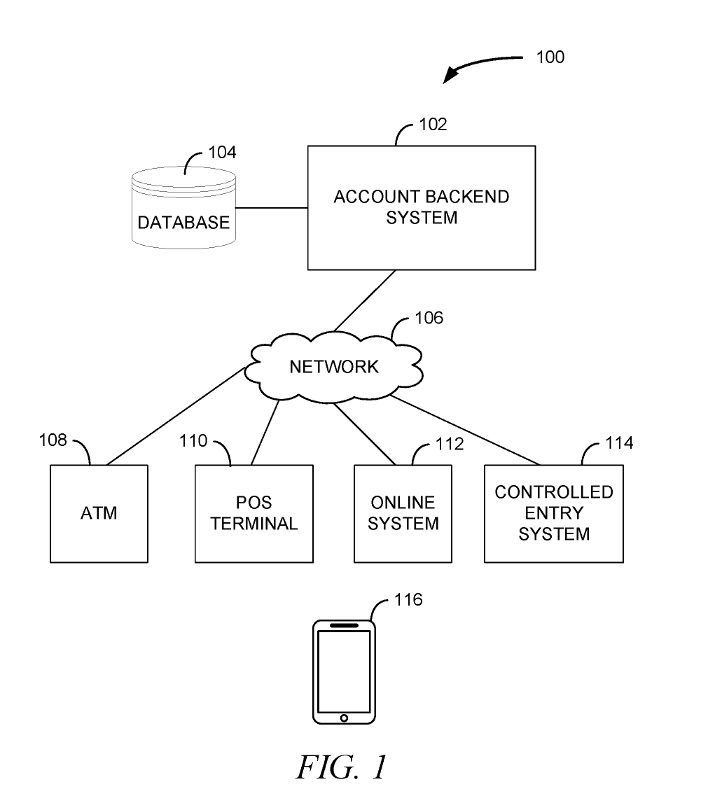

FIG. 1 is a logical block diagram of a system 100, according to an example embodiment. The system 100 is an example of a system on which various embodiments may be implemented. Note that the system 100 is illustrated and described in greatly simplified form. For example, when the subject transactions are payment authorization transactions, the system 100 also typically includes one or more additional data processing entities such as an interchange payment processing entity that operates to route payment authentication requests and authorizations and denials.

As illustrated, the system 100 includes an account backend system 102 that receives transaction authorization requests via a network 106 from particular networked entities. The network entities may include ATMs 108, POS terminals 110, online systems 112 such as computer systems of online retailers and payment processors, controlled entry systems 114, and mobile devices 116, among others. Generally, the network entities are computing devices where customers or other users conduct transactions requiring authorization from the account backend system 102. Thus, the network entity types may vary depending on the type of authorization that the account backend system 102 is deployed to service. For example, the account backend system 102 may be a bank or bankcard issuer system that operates to authenticate payment account transaction requests, which may also or alternatively include bank account withdrawals. The account backend system 102 may also be a system deployed to authenticate people attempting to enter or depart a facility via a controlled entry system 114 that may control access to a facility, transportation services such as an airliner or bus, and the like.

The account backend system 102 includes or has network 106 access to a database 104. The database 104 stores data in support of the account backend system, such as account balances, recent transactions, issued tickets, controlled passages a user is authorized to pass through, and the like. The database 104 may use some such data and other data as evidence in support of approving or denying a transaction request, such as for a payment. Such other data may include data representative of a known location of the account holder, a location from where a user last logged in to an online account, phone numbers, and the like.

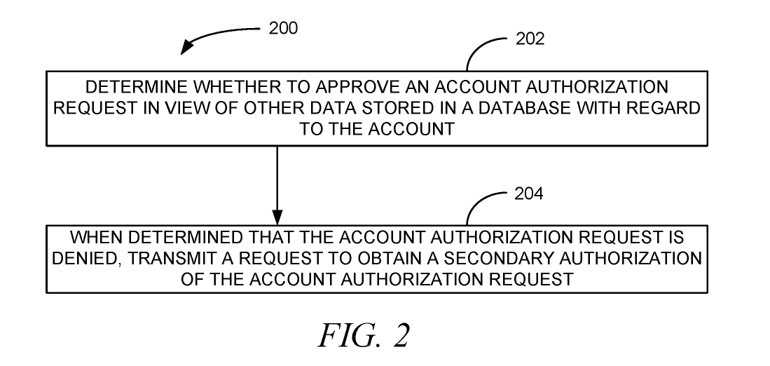

FIG. 2 is a block flow diagram of a method 200, according to an example embodiment. The method 200 is an example of a method that may be performed on the account backend system 102 of FIG. 1. The method 200 includes determining 202 whether to approve an account authorization request in view of other data stored in a database with regard to the account. The account authorization request is typically received via the network 106 from one of the network entities 108, 110, 112, 114, 116. When determined 202 that the account authorization request is denied, the method 200 includes transmitting 204 a request to obtain a secondary authorization of the account authorization request.

In some embodiments, transmitting 204 the secondary authorization request includes transmitting a request for secondary authorization input via at least one of:
a simple message service (SMS) or multimedia message service (MMS) message to a mobile device of a holder of the account;
an in-app message to an app that executes on a mobile device of the holder of the account;
an electronic message to a teller or clerk station located in proximity to a location where the account authorization request originated; and
an automated interactive voice response telephone call to a phone number associated with the holder of the account.

In some such embodiments of the method 200, transmitting 204 a request for secondary authorization input via an SMS or SMS message or an in-app message includes generating an image with a barcode included therein, such as a Quick Response (QR) code or other barcode, and adding the generated image to the message such that the barcode in the image may be presented for scanning to perform the secondary authentication.

In some embodiments of the method 200, the determining 202 of whether to approve the account authorization request includes applying at least one rule against the account authorization request and the other data stored in the database with regard to the account. In some such embodiments, the at least one rule applied is chosen based on the other data stored in the database that is available with regard to the account. The other data may include one or a plurality of
data identifying, or from which an identification can be made of, a location from which a holder of the account last logged in to the account (e.g., a BLUETOOTH® beacon identifier, coordinates within a defined area, latitude and longitude coordinates, UPS data, etc.);
data identifying a date, time, and location of at least one recent transaction;
a detected location of a mobile device of the holder of the account; and
the like.

In some such embodiments, the detected location of the mobile device of the holder of the account includes data stored to the database, directly or indirectly, by an app that executes on the mobile device of the holder of the account, the app reporting the location data based on data received by the app by an ancillary device of the mobile device. The ancillary device of the mobile device may be a radio transceiver device, such as a BLUETOOTH® beacon device, WI-FI® access point, or wireless service access point. The location data may include an identifier of the radio beacon device as received by a radio transceiver device of the mobile device (BLUETOOTH® transceiver, WI-FI® transceiver, wireless service transceiver, near-field communication transceiver, etc.) and provided to the app that executes on the mobile device.

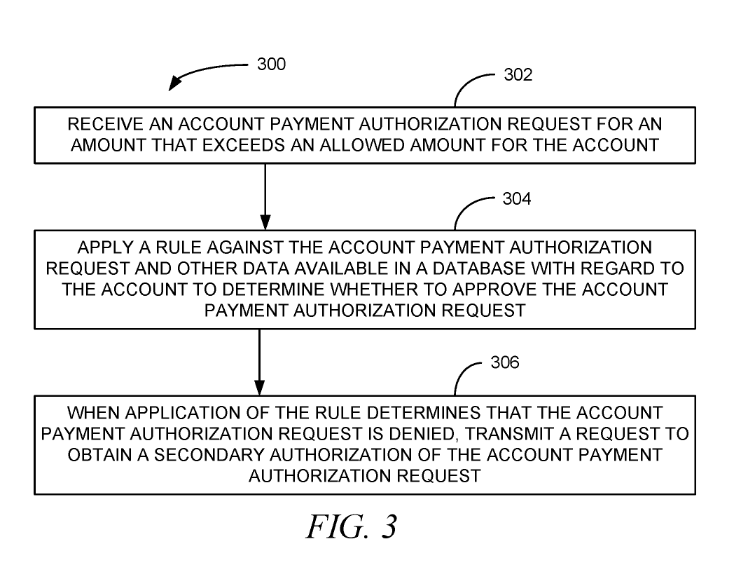

FIG. 3 is a block flow diagram of a method 300, according to an example embodiment. The method 300 is another example of method that may be performed on the account backend system 102 of FIG. 1. The method 300 includes receiving 302 an account payment authorization request for an amount that exceeds an allowed amount for the account. The method 300 then applies 304 a rule against the account payment authorization request and other data available in a database with regard to the account to determine whether to approve the account payment authorization request. When application 304 of the rule determines that the account payment authorization request is denied, the method 300 transmits 306 a request to obtain a secondary authorization of the account payment authorization request.

In some such embodiments of the method 300, the rule identifies a plurality of data items to consider as factors, which when present in the database are assigned weighted values based on the respective values of the data items. Further, the rule defines at least one of one or more individual weighted values and a sum of weighted values that determine whether the account payment authorization request is to be approved or denied subject to obtaining the secondary authorization.

In some embodiments, receiving 302 the account payment authorization request includes receiving a payment authorization request from an entity receiving a payment tender associated with the account of the account payment authorization request. The payment tender may be received through a provisioning of one of a bankcard, a wireless signal from a customer device such as a mobile device, and a set of bankcard or account data via an input mechanism of a computing device.

Transmitting 306 the secondary authorization request in some embodiments of the method 300 is performed via one or more transmission mechanisms as defined within data in association with the account, such as a user preference to receive an SMS message at a certain mobile number, a message via a social media platform, an email, an in app message, and the like. In these and some other embodiments, transmitting 306 the secondary authorization request includes transmitting a request for secondary authorization input via at least one of an SMS message to a mobile device of a holder of the account, an in-app message to an app that executes on a mobile device of the holder of the account, an electronic message to a teller or clerk station located in proximity to a location where the account payment authorization request originated, and an automated interactive voice response telephone call to a phone number associated with the holder of the account.

In some embodiments, the method 300 further includes receiving a satisfactory reply to the request for secondary authorization and approving the account payment authorization request.

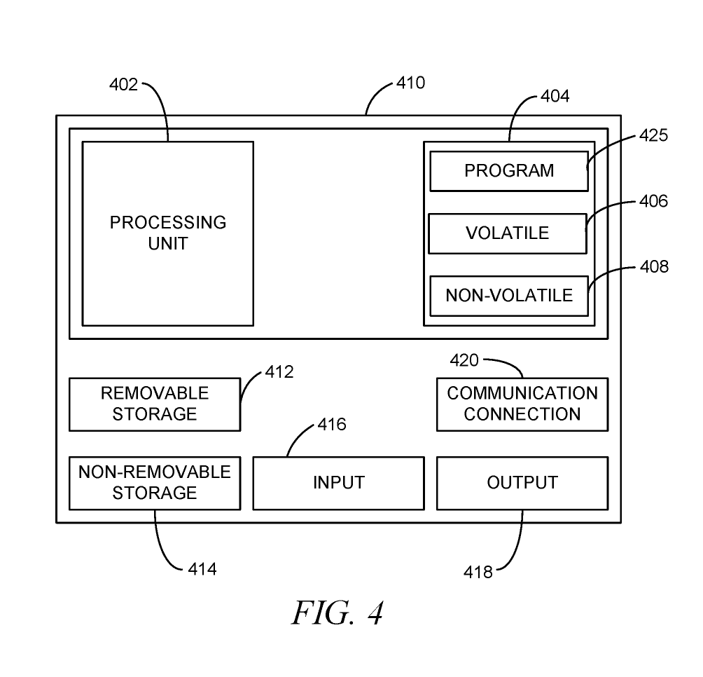

FIG. 4 is a block diagram of a computing device, according to an example embodiment. In one embodiment, multiple such computer systems are utilized in a distributed network to implement multiple components in a transaction-based environment. An object-oriented, service--oriented, or other architecture may be used to implement such functions and communicate between the multiple systems and components. The computing device of FIG. 4 may take different forms in individual and different embodiments. For example, a computer of the ATM 108, a computer of the POS terminal 110, an online computer system 112, a controlled entry system 114, a mobile device 116, and an account backend system 102 of FIG. 1. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 4. Devices such as smartphones, tablets, and smartwatches are generally collectively referred to as mobile devices. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area. Network (WAN), the Internet, and other networks. In some embodiments, the communication connection 420 may also or alternatively include a transceiver device, such as a BLUETOOTH® device that enables the computer 410 to wirelessly receive, data from and transmit data to other BLUETOOTH® devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non--transitory computer-readable medium.

Another embodiment is in the form of a multi-channel authorization method. This method includes receiving a transaction request from a customer via a first channel and ascertaining whether additional authentication is required based on an acceptable risk criterion, such as an amount of the transaction, a time of day, a location proximate to a current or recent customer location, and the like. The method may then gather enrichment evidence from an evidence supplier without customer or staff member interaction in the event that the acceptable risk criterion is not met. The method may then fulfill the transaction in the event that the enrichment evidence meets an acceptance criterion.

In some such embodiments, the acceptable risk criterion is met when the transaction is for a value below a transaction threshold. The accept risk criterion may also be met when the transaction is similar to a previous accepted transaction or in a location previously used for accepted transactions. The evidence supplier in some such embodiments may include a beacon located in a bank branch or other transaction fulfillment center and a repository storing login information for the customer's online or mobile banking facility. Further, the acceptance criterion may include a transaction request originating at a physical location or online location that is consistent with a detected physical or online presence of the customer at a time proximate to when the transaction request was submitted. In some embodiments, this method further includes requesting a secondary form of authentication from the customer in the event that the acceptance criterion is not met and fulfilling the transaction when the secondary form of authentication is validated.

A further embodiment is in the form of a multi-channel authentication system. This multi-channel authentication system includes a first transaction channel located in a fulfillment center, such as a POS terminal at a retail outlet. This multi-channel authentication system further includes a multi-channel authentication controller coupled to the first transaction channel. The multi-channel authentication controller typically includes a processor and a memory storing instructions executable on the processor to perform data processing activities. In some embodiments, the data processing activities include receiving a transaction from the first transaction channel and the mobile device carried by the customer. The data processing activities also include approving the received transaction based in part on a beacon device identifier of a beacon device reported by a mobile device app that executes on the mobile device carried by the customer, the beacon device of the beacon device identifier located proximately to the the fulfillment center.

The transaction fulfillment center may be a bank branch, a retail outlet, a restaurant, a controlled access point, and the like. The first transaction channel may be a self-service terminal, a teller counter, an assisted service terminal, a controlled access point entry and egress regulating device, and the like.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving an account payment authorization request for an amount that exceeds an allowed amount for the account;
applying a rule against the account payment authorization request and other data available in a database with regard to the account to determine whether to approve the account payment authorization request; and
when application of the rule determines that the account payment authorization request is denied, transmitting a request to obtain a secondary authorization of the account payment authorization request.

2. The method of claim 1, wherein:
the rule identifies a plurality of data items to consider as factors, which when present in the database are assigned weighted values based on the respective values of the data items; and
the rule defines at least one of one or more individual weighted values and a sum of weighted values that determine whether the account payment authorization request is to be approved or denied subject to obtaining the secondary authorization.

3. The method of claim 1, wherein receiving the account payment authorization request includes receiving a payment authorization request from an entity receiving a payment tender associated with the account of the account payment authorization request.

4. The method of claim 3, wherein the payment tender is received through a provisioning of one of a bankcard, a wireless signal from a customer device, and a set of bankcard or account data via an input mechanism of a computing device.

5. The method of claim 1, wherein transmitting the secondary authorization request is performed via one or more transmission mechanisms as defined within data in association with the account.

6. The method of claim 1, wherein transmitting the secondary authorization request includes transmitting a request for secondary authorization input via at least one of:
an SMS message to a mobile device of a holder of the account;
an in-app message to an app that executes on a mobile device of the holder of the account;
an electronic message to a teller or clerk station located in proximity to a location where the account payment authorization request originated; and
an automated interactive voice response telephone call to a phone number associated with the holder of the account.

7. The method of claim 1, further comprising:
receiving a satisfactory reply to the request for secondary authorization; and approving the account payment authorization request.

8. The method of claim 1, wherein the other data available in the database includes:
data identifying, or from which an identification can be made of, a location from which a holder of the account last logged in to the account;
data identifying a date, time, and location of at least one recent transaction; and
a detected location of a mobile device of the holder of the account.

9. The method of claim 1, wherein the allowed amount for the account is zero based on a prior potential or actual account fraud activity determination.

10. A multi-channel authorization method comprising:
receiving a transaction request from a customer via a first channel;
ascertaining whether additional authentication is required based on an acceptable risk criterion;
gathering enrichment evidence from an evidence supplier without customer or staff member interaction in the event that the acceptable risk criterion is not met; and
fulfilling the transaction in the event that the enrichment evidence meets an acceptance criterion.

11. The method of claim 10, wherein the acceptable risk criterion is met when the transaction is for a value below a transaction threshold.

12. The method of claim 11, wherein the accept risk criterion is also met when the transaction is similar to a previous accepted transaction or in a location previously used for accepted transactions.

13. The method of claim 10, wherein the evidence supplier includes at least one of:
a beacon located in a bank branch or other transaction fulfillment center; and
a repository storing login information for the customer's online or mobile banking facility.

14. The method of claim 10, wherein the acceptance criterion comprises:
a transaction request originating at a physical location or online location that is consistent with a detected physical or online presence of the customer at a time proximate to when the transaction request was submitted.

15. The method of claim 10, further comprising:
requesting a secondary form of authentication from the customer in the event that the acceptance criterion is not met; and
fulfilling the transaction when the secondary form of authentication is validated.

16. A multi-channel authentication system comprising:
a first transaction channel located in a fulfillment center; and
a multi-channel authentication controller coupled to the first transaction channel, the multi-channel authentication controller including a processor and a memory storing instructions executable on the processor to perform data processing activities comprising:
receiving a transaction from the first transaction channel and the mobile device carried by the customer; and
approving the received transaction based in part on a beacon device identifier of a beacon device reported by a mobile device app that executes on the mobile device carried by the customer, the beacon device of the beacon device identifier located proximately to the the fulfillment center.

17. The multi-channel authentication system of claim 16, wherein the transaction fulfillment center is at least one of a bank branch, a retail outlet, a restaurant, and a controlled access point.

18. The multi-channel authentication system of claim 16, wherein the first transaction channel is at least one of a self-service terminal, a teller counter, an an assisted service terminal.
